(19) United States
(12) Patent Application Publication
(10) Pub. No.: US 2026/0208335 A1
(43) Pub. Date: Jul. 23, 2026

(54) DRIVE PLATE SYSTEMS, METHODS, AND APPARATUS FOR A PRESS TOOL

(71) Applicant: Tiger Tool International Incorporated, Abbotsford (CA)

(72) Inventor: Michael Andrews, Bellingham, WA (US)

(73) Assignee: Tiger Tool International Incorporated, Abbotsford (CA)

(21) Appl. No.: 19/549,387

(22) Filed: Feb. 25, 2026

Related U.S. Application Data
(63) Continuation of application No. 18/405,887, filed on Jan. 5, 2024, now Pat. No. 12,583,084.
(60) Provisional application No. 63/478,892, filed on Jan. 6, 2023.

(51) Int. Cl. B25B 27/02

(52) U.S. Cl. CPC B25B 27/023

(57) ABSTRACT

A drive plate assembly for a king pin removal tool comprising a drive member, the drive plate assembly comprises a drive plate and an insert. The drive plate defines a main opening and a flange recess. The insert comprises a shaft portion and a flange portion and defining a drive opening. The insert is arranged such that the shaft portion is within the main opening, the flange portion is within the flange recess, and the drive member is adapted to be threaded into the drive opening. When the drive member is received within the drive opening and axially rotated relative to the insert, a drive force applied by the drive member forces the flange portion of the insert against a surface of the drive plate defining at least a portion of the flange recess.

### RELATED APPLICATIONS

This application (Attorney's Ref. No. P220752) is a continuation of U.S. patent application Ser. No. 18/405,887 filed Jan. 5, 2024, currently pending.

U.S. patent application Ser. No. 18/405,887 claims benefit of U.S. Provisional Application Ser. No. 63/478,892 filed Jan. 6, 2023, now expired.

The contents of all related applications are incorporated herein by reference.

### TECHNICAL FIELD

The present invention relates to press tool systems, methods, and apparatus and, in particular, to a drive plate of a tool for removing the king pin from a king pin assembly.

### BACKGROUND

The present invention relates to any press tool that comprises a threaded opening in drive plate, a threaded rod configured to engage the threaded opening, and a frame supported by the drive plate during operation of the press tool. The present invention is of particular significance when used as part of a king pin removal tool, and that application of the present invention will be described in detail herein. But the principles of the present invention may be applied to other press tools, such as bearing pullers, jaw pullers, clamps, or the like.

U.S. Pat. No. 9,511,488 to Andrews et al. (“the '488 patent”) discloses a king pin removal tool for displacing a king pin along a king pin axis relative to an axle member and a knuckle assembly. The '488 patent is incorporated herein by reference.

A king pin removal tool such as the example king pin removal tool disclosed in the '488 patent comprises a drive plate defining a drive opening, an anchor plate, a drive member, a spacing system, and a stabilizing system. The drive member engages the drive plate such that rotation of the first drive member relative to the drive plate displaces the first drive member through the drive opening and along the king pin axis to displace the king pin along the king pin axis relative to the axle member and the knuckle assembly.

Accordingly, when using a drive pin removal tool such as that shown in the '488 patent, a rigid structure is defined by the drive plate, the anchor plate, and the spacing system. The knuckle assembly and axle member are supported by the anchor plate, the drive member is supported by the drive plate, and a distance between the anchor plate and the drive plate is fixed by the spacing system. In this example, the drive member threadingly engages a surface on the drive plate such that axial rotation of drive member relative to the drive plate applies a drive load to the king pin along the king pin axis. The drive load is thus transferred from the drive member to the drive plate through a threaded internal surface of the drive plate defining the drive opening.

The drive load required to remove a king pin from the axle member and the knuckle assembly is significant and may result in flexing of the drive plate. Flexing of the drive plate under the drive load may eventually result in failure of the drive plate and/or drive member, especially the threaded surfaces thereof. The drive plate is a relatively expensive part.

### SUMMARY

The present invention may be embodied as a drive plate assembly for a king pin removal tool comprising a drive member. The drive plate assembly comprises a drive plate defining a main opening and a flange recess and an insert comprising a shaft portion and a flange portion and defining a drive opening. The insert is arranged such that the shaft portion is within the main opening, the flange portion is within the flange recess, and the drive member is adapted to be threaded into the drive opening. When the drive member is received within the drive opening and axially rotated relative to the insert, a drive force applied by the drive member forces the flange portion of the insert against a surface of the drive plate defining at least a portion of the flange recess.

The present invention may also be embodied as a method of forming a drive plate assembly for a king pin removal tool comprising a drive member, the method comprising the following steps. A drive plate defining a main opening and a flange recess is provided. An insert comprising a shaft portion and a flange portion and defining a drive opening is provided. The insert is arranged such that the shaft portion is within the main opening, the flange portion is within the flange recess, and the drive member is adapted to be threaded into the drive opening. When the drive member is received within the drive opening and axially rotated relative to the insert, displacing the drive member to apply a drive force to force the flange portion of the insert against a surface of the drive plate defining at least a portion of the flange recess.

### BRIEF DESCRIPTION OF THE DRAWINGS

FIG. 1 is an exploded front elevation view depicting an example king pin removal tool incorporating a first example drive plate assembly of the present invention;

FIG. 2 is a perspective view of the first example drive plate assembly;

FIG. 3 is a bottom plan view of the first example drive plate assembly;

FIG. 4 is a perspective view of an insert forming part of the first example drive plate assembly;

FIG. 5 is a vertical section view of the example king pin removal tool incorporating the first example drive plate assembly, the king pin removal tool depicted in FIG. 5 immediately prior to the process of removing a king pin;

FIG. 6 is a section view taken along lines 6-6 in FIG. 5;

FIG. 7 is a vertical section view similar to that of FIG. 5, the king pin removal tool being depicted during the process of removing a king pin in FIG. 7.

### DETAILED DESCRIPTION

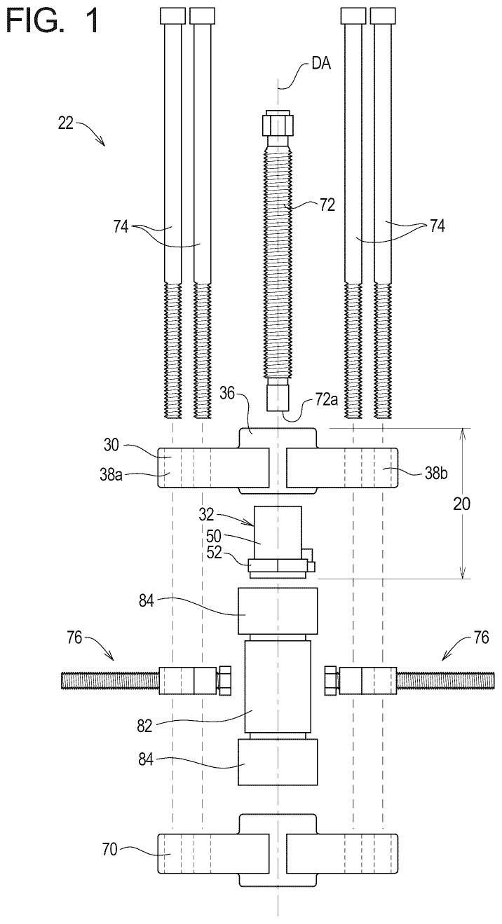

Referring initially to FIGS. 1-3 of the drawing, depicted therein is a first example drive plate assembly 20 constructed in accordance with, and embodying, the principles of the present invention. The example drive plate assembly 20 as depicted in FIGS. 1, 5, and 7 illustrates the first example drive plate assembly 20 as part of a king pin removal tool 22. The example king pin removal tool 22 is or may be constructed and operated in the same manner as the king pin removal tool disclosed in the '488 patent and will be described herein only to that extent helpful to a complete understanding of the present invention.

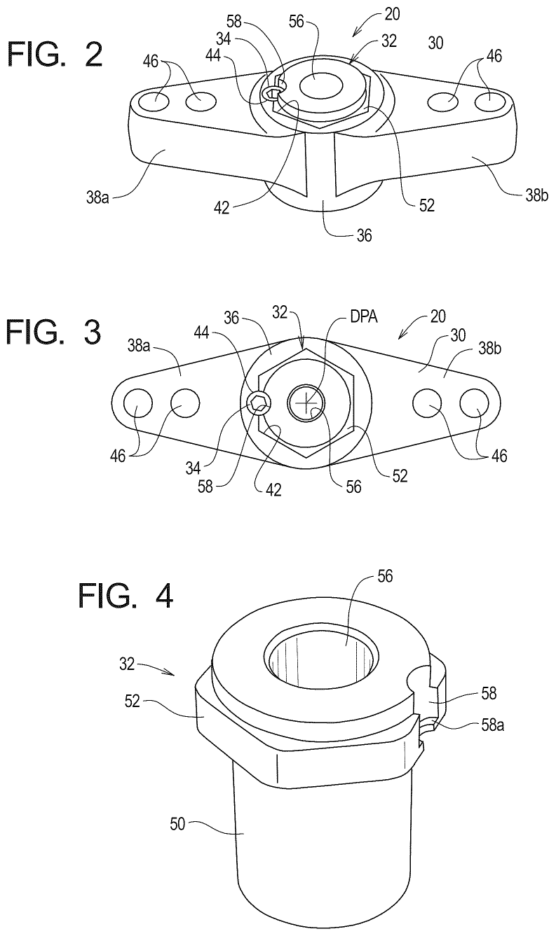

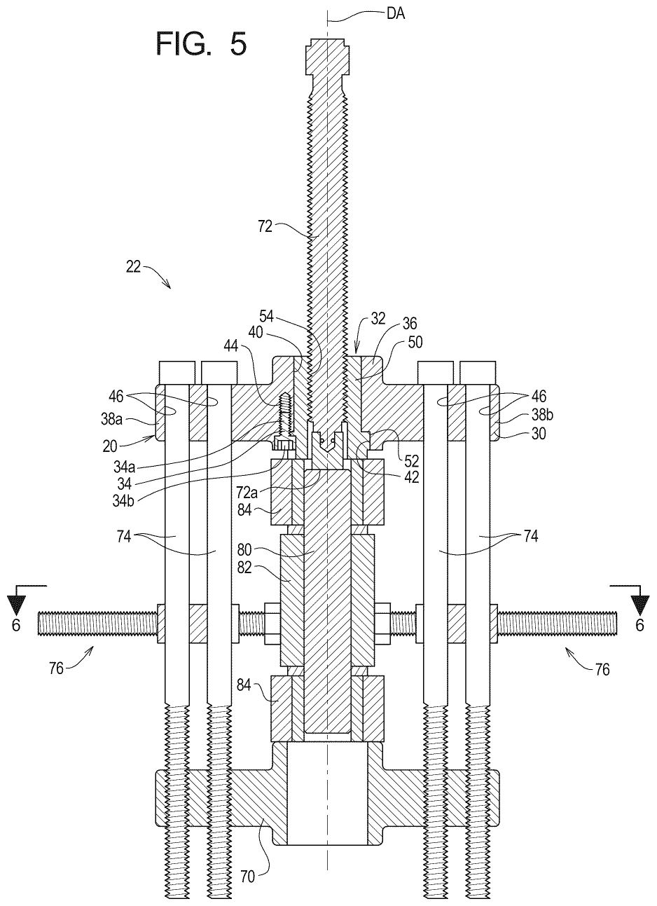

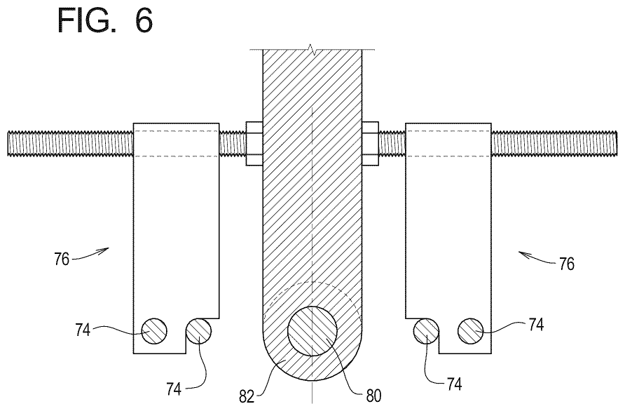

As perhaps best shown in FIGS. 1-3, 5 and 7, the example drive plate assembly 20 comprises a drive plate 30, an insert 32, and at least one fastener 34. As shown in FIGS. 2 and 3, the example drive plate 30 is configured to define a central portion 36 and first and second wing portions 38a and 38b as best shown in FIGS. 1 and 2. FIG. 5 best illustrates that the example drive plate 30 defines a main opening 40, a flange recess 42, a fastener recess 44, and a plurality of brace openings 46. FIGS. 1, 4 and 5 best illustrate that the example insert 32 comprises a shaft portion 50, a flange portion 52, and an insert projection 54. FIGS. 3 and 4 illustrate that a drive opening 56 extends through the example insert 32. FIG. 4 further illustrates that the example insert 32 also defines a fastener recess, notch, or opening 58 and fastener surface 58a.

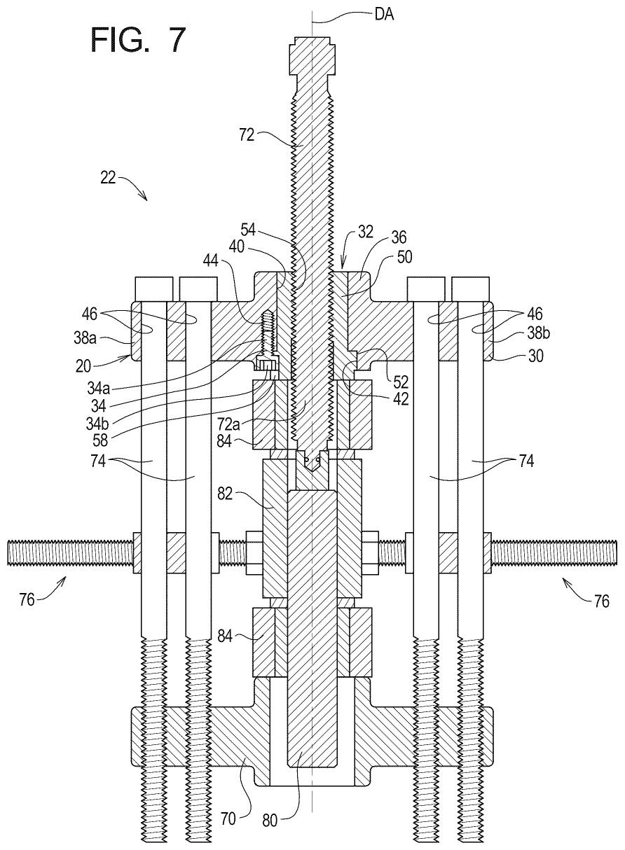

To allow the example drive plate 30 to accommodate the example insert 32, the example central portion 36 is generally cylindrical and has a diameter that is larger than that of a diameter of the main opening 40 of the drive plate 30. The example wing portions 38a and 38b are arranged to extend from the central portion 36. The central portion 36 and wing portions 38a and 38b are sized, dimensioned, and made of material capable of allowing the example drive plate 30 to bear the loads exerted on the drive plate 30 by the drive member 72 (through the insert member 32) and the spacing members 74 during use of the example king pin removal tool 22. As perhaps best shown in FIGS. 5 and 7, a dimension of the central portion 36 in a direction along the drive axis DA is greater than that of dimensions of the wing portions 38a and 38b in the direction along the drive axis DA. Although the example drive plate 30 comprises two wing members 38a and 38b, a drive plate of the present invention may be provided with more than two wing members and associated spacing members 74.

The example main opening 40 and a flange recess 42 of the example drive plate 30 are symmetrically arranged relative to and coaxially aligned with a drive plate axis DPA. The example fastener recess 44 and brace openings 46 are offset from the drive plate opening axis DPA. The shaft portion 50, the flange portion 52, and the insert projection 54 of the insert 32 are symmetrically arranged relative to and coaxially aligned with a drive axis DA.

Further, the example main opening 40 in the drive plate 30 and the example shaft portion 50 of the insert 32 are both cylindrical, with the example shaft portion 50 being sized and dimensioned to fit within the main opening 40.

FIGS. 5 and 7 illustrate that, with the insert 34 arranged within the main opening 40, a shaft portion 34a of the fastener is received by the fastener recess 44 and a head portion 34b of the fastener 34 engages the fastener surface 58a to inhibit movement of the insert 32 along the drive axis DA and out of the main opening 40 relative to the drive plate 30.

The example flange recess 42 defines a flange recess perimeter shape, and the example flange portion 52 of the insert 32 defines a flange portion perimeter shape. The flange portion perimeter shape is sized and dimensioned relative to the flange recess perimeter shape to allow the flange portion 52 to fit within flange recess 42. Further, the flange recess perimeter shape and the flange portion perimeter shape are configured to inhibit or prevent axial rotation of the insert 32 relative to the drive plate 30 during normal use of the example drive plate assembly 20. The flange portion perimeter shape of the example flange portion 52 and the example flange recess perimeter shape are both hexagonal, with the flange recess perimeter shape being slightly larger than the flange portion perimeter shape. Accordingly, the example flange recess 42 and the example flange portion 52 define complementary corners, points, projections, surfaces or the like that engage each other to inhibit rotation of the insert 32 relative to the drive plate 30 about the drive axis DA.

The example fastener 34 is adapted to extend through the fastener recess, notch, or opening 58 and into the fastener recess 44 to detachably attach the insert 32 to the drive plate 30 when the shaft portion 50 is within the main opening 40 and the flange portion 52 is within the flange recess 42. The example fastener 34 further engages at least the example fastener recess, notch, or opening 58 to inhibit or prevent axial rotation of the insert 32 relative to the drive plate 30 during normal use of the example drive plate assembly 20.

The example drive opening 56 is substantially cylindrical and threaded. Further, when the shaft portion 50 is within the main opening 40 and the flange portion 52 is within the flange recess 42, the drive opening 56 is substantially coaxially aligned with the main opening 40 such that the drive plate axis DPA and drive axis DA are coaxially aligned.

As shown in FIGS. 1, 5, and 7, in addition to the first example drive plate assembly 20, the example king pin removal tool 22 further comprises an anchor plate 70, a drive member 72, a plurality of spacing members 74, and a plurality of brace assemblies 76. The example king pin removal tool 22 comprises two sets of two spacing members 74, one set arranged on each side of the drive plate 30 in a symmetrical manner. FIGS. 1, 5, and 7 further illustrate an example king pin 80, axle member 82, and knuckle assembly 84.

When the example king pin removal tool 22 is formed, the drive plate 30 is supported by the spacing members 74 such that the flange recess 42 faces the anchor plate 70. The insert 32 is then arranged such that the shaft portion 50 is within the main opening 40 and the flange portion 52 is within the flange recess 42. The fastener 34 is then inserted at least partly through recess, notch, or opening 58 and threaded into the fastener recess 44 to detachably attach the insert 32 to the drive plate 30. At this point, the insert projection 54 faces the anchor plate 70. The example drive member 72 is then threaded into the drive opening 56 such that a drive end 72a thereof is arranged between the insert 32 and the anchor plate 70.

When removing the example king pin 80 from the axle member 82 and knuckle assembly 84, the king pin 80 is arranged between the drive end 72a of the drive member 72 and coaxially aligned with the drive axis DA and the knuckle assembly 84 supported by the anchor plate 70. Further axial rotation of the drive member 72 forces the king pin 80 out of the axle member 82 and the knuckle assembly 84.

The use of the insert member 32 at least partly isolates any flexing of the drive plate 30 from the interface of the threaded outer surface of the drive member 72 and the threaded inner surface defining the drive opening 56 of the insert 32. And should the threaded interface formed by the drive member 72 and the insert 32 fail or otherwise become unusable, the drive plate assembly 20 may be repaired by replacing the failed drive member 72 and/or insert 32 with a new drive member 72 and/or insert 32. In comparison with the cost of the drive plate 30, the drive member 72 and insert are relatively inexpensive.

What is claimed is:

1. A drive plate assembly for a king pin removal tool comprising a drive member, the drive plate assembly comprising:
a drive plate defining a main opening and a flange recess;
an insert comprising a shaft portion and a flange portion and defining a drive opening; wherein
the shaft portion is supported in the main opening,
the flange portion is supported in the flange recess,
the drive opening is configured to engage at least a portion of the drive member;
when the drive member is received within the drive opening and axially rotated relative to the insert, the flange portion engages the flange recess to inhibit movement of the insert relative to the drive plate.

2. The drive plate assembly as recited in claim 1, in which the flange portion engages the flange recess to inhibit rotation of the insert relative to the drive plate.

3. The drive plate assembly as recited in claim 1, in which:
the flange portion defines a flange portion perimeter shape;
the flange recess defines a flange recess perimeter shape; and
the flange portion perimeter shape and the flange recess perimeter shape are configured such that the flange portion engages the drive plate to inhibit rotation of the insert relative to the drive plate.

4. The drive plate assembly as recited in claim 1, in which:
the flange portion defines a first hexagonal shape;
the flange recess defines a second hexagonal shape; and
the second hexagonal shape is configured relative to the first hexagonal shape such that the flange portion is received within the flange recess and the flange portion engages the drive plate to inhibit rotation of the insert relative to the drive plate.

5. The drive plate assembly as recited in claim 1, further comprising a fastener arranged to secure the insert to the drive plate.

6. The drive plate assembly as recited in claim 5, in which the drive plate defines a fastener recess that engages the fastener to secure the insert to the drive plate.

7. The drive plate assembly as recited in claim 5, in which the insert defines a fastener surface, where the fastener engages the fastener surface to secure the insert to the drive plate.

8. The drive plate assembly as recited in claim 5, in which:
the drive plate defines a fastener recess;
the insert defines a fastener surface; wherein
a shaft of the fastener engages the fastener recess to secure the fastener to the drive plate; and
a head of the fastener engages the fastener surface to secure the insert relative to the drive plate.

9. The drive plate assembly as recited in claim 5, in which the insert defines a fastener recess to accommodate at least a portion of the fastener.

10. The drive plate assembly as recited in claim 8, in which the insert defines a fastener recess configured to accommodate the head portion of the fastener when the head portion of the fastener engages the fastener surface.

11. A method of adapting a king pin removal tool comprising a drive member, the method comprising the steps of:
providing a drive plate assembly comprising
a drive plate defining a main opening and a flange recess;
an insert comprising a shaft portion and a flange portion and defining a drive opening;
supporting the shaft portion in the main opening,
supporting the flange portion in the flange recess,
configuring the drive opening to engage at least a portion of the drive member; and
when the drive member is received within the drive opening and axially rotated relative to the insert, configuring the flange portion to engage the flange recess to inhibit movement of the insert relative to the drive plate.

12. The method as recited in claim 11, in which:
the flange portion defines a flange portion perimeter shape;
the flange recess defines a flange recess perimeter shape; and
the flange portion perimeter shape and the flange recess perimeter shape are configured such that the flange portion engages the drive plate to inhibit rotation of the insert relative to the drive plate.

13. The method as recited in claim 11, in which:
the flange portion defines a first hexagonal shape;
the flange recess defines a second hexagonal shape; and
the second hexagonal shape is configured relative to the first hexagonal shape such that the flange portion is received within the flange recess and the flange portion engages the drive plate to inhibit rotation of the insert relative to the drive plate.

14. The method as recited in claim 11, further comprising the step of arranging a fastener to secure the insert to the drive plate.

15. The method as recited in claim 14, in which
a fastener recess is defined by at least one of the drive plate and the insert,
a fastener surface is defined by at least one of the drive plate and the insert, and
at least a portion of the fastener is arranged in at least one of the fastener surface and the fastener recess to secure the insert to the drive plate.

16. The method as recited in claim 15, in which
a first portion the fastener engages the fastener recess, and,
a second portion of the fastener engages the fastener surface.

17. A drive plate assembly for a king pin removal tool comprising a drive member, the drive plate assembly comprising:
a drive plate defining
a main opening, and
a flange recess defining a flange recess perimeter shape;
an insert comprising
a shaft portion, and
a flange portion defining a flange portion perimeter shape and a drive opening; wherein
the shaft portion is supported in the main opening,
the flange portion is supported in the flange recess,
the drive opening is configured to engage at least a portion of the drive member;
when the drive member is received within the drive opening and axially rotated relative to the insert, the flange portion engages the flange recess such that the flange portion perimeter shape engages the flange recess perimeter shape to inhibit movement of the insert relative to the drive plate.

18. The drive plate assembly as recited in claim 17, in which:
the flange portion perimeter shape defines a first hexagonal shape;
the flange recess perimeter shape defines a second hexagonal shape; and
the second hexagonal shape is configured relative to the first hexagonal shape such that the flange portion is received within the flange recess and the flange portion engages the drive plate to inhibit rotation of the insert relative to the drive plate.

19. The drive plate assembly as recited in claim 17, further comprising a fastener to secure the insert to the drive plate.

20. The drive plate assembly as recited in claim 17, in which
a fastener recess is defined by at least one of the drive plate and the insert,
a fastener surface is defined by at least one of the drive plate and the insert, and
at least a portion of the fastener is arranged in at least one of the fastener surface and the fastener recess to secure the insert to the drive plate.
